(19) United States
(12) Patent Application Publication
(10) Pub. No.: US 2006/0033820 A1
(43) Pub. Date: Feb. 16, 2006

(54) Image combining apparatus

(75) Inventors: Yoshimasa Honda, Kamakura-shi (JP); Tsutomu Uenoyama, Kawasaki-shi (JP)

Correspondence Address: NATH & ASSOCIATES, 112 South West Street, Alexandria, VA, 22314, US

(73) Assignee: MATSUSHITA ELECTRIC INDUSTRIAL CO., Ltd., Osaka (JP)

(21) Appl. No.: 10/514,439

(22) PCT Filed: Feb. 20, 2004
(86) PCT No.: PCT/JP04/01990

§ 371 Date: Nov. 16, 2004

(30) Foreign Application Priority Data
Feb. 25, 2003 (JP) 2003-047354

(51) Int. Cl. H04N 5/225

(52) U.S. Cl. 348/218.1

(57) ABSTRACT

A picture combining apparatus that automatically displays a picture important to a user, and moreover displays that important picture combined in a screen configuration that is highly appealing visually. In this apparatus, a picture input section 102 inputs images making up a picture on an image-by-image basis, and a picture accumulation section 110 accumulates input pictures. A trigger generation section 104 that generates a trigger indicating the importance of a picture, and a combining trigger calculation section 106 calculates a combining trigger for calculating screen combining parameters using that trigger. A screen configuration calculation section 108 determines the presence or absence of screen combining using a combining trigger and calculates a screen configuration (more specifically, screen combining parameters). A sub image creation section 112 creates an image (sub image) to be used in combination with an input image (main image), and an image information adding section 114 adds image information of a sub image to that sub image. A screen combining section 116 combines a plurality of images (main and sub images) in one screen.

### TECHNICAL FIELD

The present invention relates to a picture combining apparatus that combines a plurality of pictures in one screen, and more particularly to a method whereby a picture important to a user is selected for combining, and an important picture is placed so as to be clearly perceptible visually within a screen.

### BACKGROUND ART

With recent advances in information communication technology and expansion of related infrastructure, by receiving pictures screenshot by a camera at a remote location via a transmission path, for example, it has become possible to carry out surveillance or monitoring of a remote location from a position distant from that camera. It is also possible for surveillance or monitoring to be carried out on a single picture receiving terminal for a plurality of pictures.

However, monitoring all such pictures without missing any requires the same number of display screens as there are camera pictures, making a picture receiving terminal not only complex but also expensive. Also, it is desirable for a picture receiving terminal that receives pictures from a plurality of cameras to be a low-priced general-purpose display terminal with only one display screen rather than an expensive special-purpose terminal.

Currently, a commonly seen type of surveillance system for playing back surveillance pictures from a plurality of cameras on a picture receiving terminal that has only one display screen is one in which pictures from a plurality of cameras are displayed sequentially on one screen using time division. As different pictures are displayed sequentially at a fixed interval on one display screen, a problem with this kind of system is that the correspondence between a displayed picture and the camera imaging the picture is difficult to grasp, and the display is difficult to view. Also, since the pictures of the plurality of cameras are displayed on a time division basis, important scenes of some cameras may be missed.

A surveillance system that combines pictures from a plurality of cameras in one screen and displays the plurality of pictures simultaneously is disclosed in Unexamined Japanese Patent Publication No. HEI 4-280594.

As shown in FIG. 1, this system has a plurality of (here, three) surveillance cameras 1-1, 1-2, and 1-3, A/D conversion sections 3-1, 3-2, and 3-3 connected to surveillance cameras 1-1 through 1-3, memories 5-1, 5-2, and 5-3 that store image data, a signal processing circuit 7 that processes image signals, a control section 9 that controls signal processing circuit 7, a D/A conversion section 11, and a monitor 13 that displays pictures. Signal processing circuit 7 includes a selection circuit 15 that selects an image signal, and a screen reducing and combining circuit 17 that reduces the size of a plurality of images and combines them in one screen.

In this system, pictures from surveillance cameras 1-1 through 1-3 are output to memories 5-1 through 5-3 via A/D conversion sections 3-1 through 3-3. Screen reducing and combining circuit 17 reduces all the pictures and combines them into one image, and outputs this to selection circuit 15. When signal processing circuit 7 receives a picture selection signal from control section 9, selection circuit 15 selects one of the pictures from the plurality of surveillance cameras, or the reduced and combined picture, in accordance with the picture selection signal, and outputs this to D/A conversion section 11. D/A conversion section 11 outputs a picture signal to monitor 13.

Thus, with this system, a plurality of pictures can be displayed on a terminal with only one display screen, and a user can easily grasp the overall picture using a plurality of pictures. Also, pictures can be switched by the user, enabling the user to select and view one picture.

However, in the above-described conventional system, a plurality of pictures are simply reduced to the same size and combined, and pictures that the user wants to see and pictures that the user does not want to see are combined at the same size, making it difficult to view pictures that are important to the user.

There is also a problem in that, when the user switches to and displays a picture he or she wants to view, important scenes in pictures not selected by the user cannot be displayed. In surveillance applications, in particular, there is a definite requirement to be able to display important scenes in the event of an abnormal occurrence or emergency, for example, but in a conventional system important scenes are missed, and it is necessary for the user himself or herself to select and display a picture in which an important scene is captured in such a situation.

### DISCLOSURE OF INVENTION

It is an object of the present invention to provide a picture combining apparatus that combines a plurality of pictures in one screen, and that can automatically display a picture that is important to the user, and furthermore can display that important picture combined in a screen configuration that is highly appealing visually.

According to one aspect of the present invention, a picture combining apparatus that combines a plurality of pictures in one screen has a picture input section that inputs a picture, a trigger generation section that generates a trigger indicating the importance of a picture, a screen configuration calculation section that calculates a screen configuration in accordance with the importance of a generated trigger, an image creation section that creates an image to be combined from an input picture based on a calculated screen configuration, and a screen combining section that combines a plurality of images including a created image in one screen.

### BRIEF DESCRIPTION OF DRAWINGS

FIG. 1 is a drawing showing an example of a conventional surveillance system;

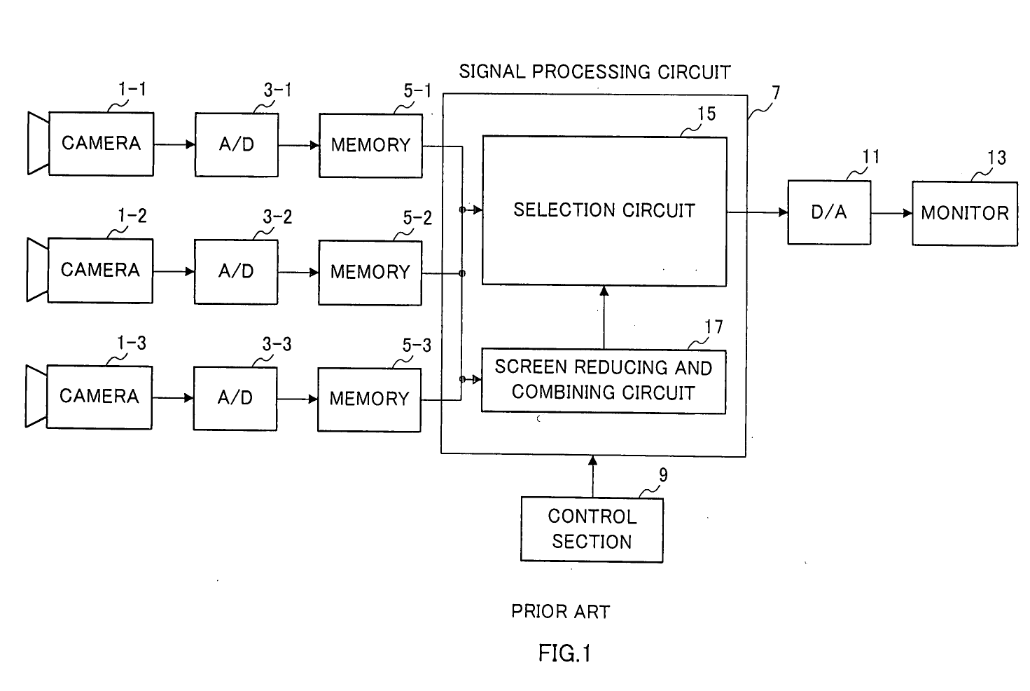

FIG. 2 is a block diagram showing the configuration of a picture combining apparatus according to one embodiment of the present invention;

FIG. 3 is a flowchart for explaining the operation of a picture combining apparatus according to this embodiment;

FIG. 4 is a flowchart showing the contents in Operation Example 1 of screen combining parameter calculation processing in FIG. 3;

FIG. 5 is an explanatory drawing showing an overview of screen combining by means of still picture combining in Operation Example 1;

FIG. 6 is a flowchart showing the contents in Operation Example 2 of screen combining parameter calculation processing in FIG. 3;

FIG. 7 is an explanatory drawing of the cut-out area calculation method in Operation Example 2;

FIG. 8 is an explanatory drawing showing an overview of screen combining by means of cut-out combining in Operation Example 2;

FIG. 9 is a flowchart showing the contents in Operation Example 3 of screen combining parameter calculation processing in FIG. 3;

FIG. 10 is a flowchart showing the contents in Operation Example 3 of picture accumulation processing in FIG. 3;

FIG. 11 is an explanatory drawing showing an overview of screen combining by means of loop combining in Operation Example 3;

FIG. 12 is a flowchart showing the contents in Operation Example 4 of screen combining parameter calculation processing in FIG. 3;

FIG. 13 is a flowchart showing the contents in Operation Example 5 of screen combining parameter calculation processing in FIG. 3; and

FIG. 14 is a flowchart showing the contents in Operation Example 6 of screen combining parameter calculation processing in FIG. 3.

### BEST MODE FOR CARRYING OUT THE INVENTION

The gist of the present invention is that, when a plurality of pictures are combined in one screen, the screen configuration is calculated (more specifically, screen combining parameters are calculated) using a trigger indicating the importance of a picture, and screen combining is performed based on the calculation results. For example, there is a case where screen combining is performed with a picture at the time of trigger generation taken as a still picture (herein after referred to as “still picture combining”), a case where screen combining is performed with a picture at the trigger generation location enlarged (hereinafter referred to as “cut-out combining”), or a case where screen combining is performed so that scenes before and after trigger generation are played back in slow motion (hereinafter referred to as “loop combining”).

Also, at this time, screen generation parameters are controlled in accordance with the size of the trigger. For example, control of the display time (in the case of “still picture combining”), the enlargement ratio (in the case of “cut-out combining”), or the playback speed, loop length, and number of loops (in the case of “loop combining”), is performed in accordance with the trigger size. Specifically, the larger the trigger, the longer is the display time, the larger is the enlargement ratio, the slower is the playback speed, the greater is the loop length, or the greater is the number of loops.

At this time, also, the display size of the picture to which the trigger applies is controlled in accordance with the size of the trigger. For example, the larger the trigger, the larger is the picture display size.

At this time, moreover, the type of screen combining is represented graphically. For example, the type of screen combining may be represented by the color or shape of the border of the image display area.

Here, the expression “a plurality of pictures” also includes a case where a plurality of picture data are generated from output of one camera in addition to the case based on output from a plurality of cameras.

Also, in this Description, individual images comprising of an input picture are defined as input images, a part composed of an entire screen in an input image is defined as a “main image,” and an item that is an image composed of an area of part of an input image and is combined with the main image is defined as a “sub image.”

With reference now to the accompanying drawings, an embodiment of the present invention will be explained in detail below.

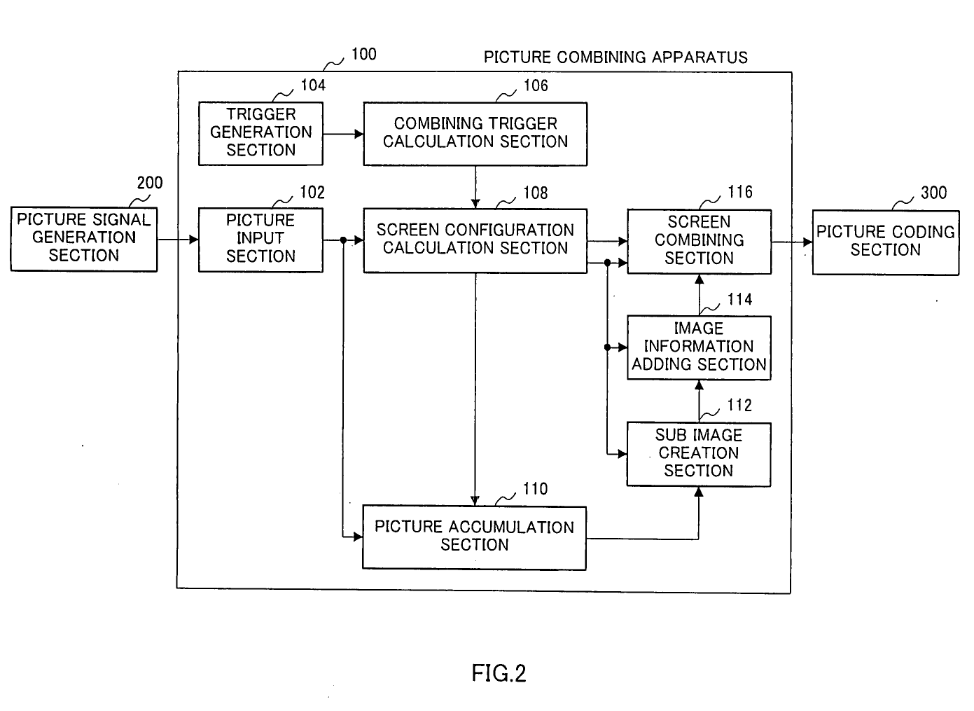

FIG. 2 is a block diagram showing the configuration of a picture combining apparatus according to one embodiment of the present invention.

This picture combining apparatus 100 has a function of combining a plurality of pictures in one screen, and has a picture input section 102 that inputs images making up a picture on an image-by-image basis, a trigger generation section 104 that generates a trigger indicating the importance of a picture, a combining trigger calculation section 106 that calculates a combining trigger for calculating screen combining parameters described later herein using a trigger from trigger generation section 104, a screen configuration calculation section 108 that determines the presence or absence of screen combining using a combining trigger and calculates a screen configuration (to be specific, screen combining parameters), a picture accumulation section 110 that accumulates pictures, a sub image creation section 112 that creates an image (sub image) to be used in combination with an input image (main image), an image information adding section 114 that adds image information of a sub image to that sub image, and a screen combining section 116 that combines a plurality of images (main and sub images) in one screen. Connected to picture combining apparatus 100 are a picture signal generation section 200 that generates a picture signal, and a picture coding section 300 that codes pictures (images) after combining.

Although not illustrated, picture signal generation section 200 may be composed of a camera and A/D conversion section, for example. There is no particular limitation on the number of cameras (and A/D conversion sections) One or more pictures output from picture signal generation section 200 are conveyed to picture input section 102 in picture combining apparatus 100.

Picture input section 102 performs input processing on a picture-by-picture basis on a picture signal output from picture signal generation section 200. Specifically, a synchronization signal is detected from an input picture signal, and images making up a picture are output to screen configuration calculation section 108 and picture accumulation section 110 on a screen-by-screen basis. At this time, picture input section 102 adds to each image an image number that is unique to an individual picture and whose value increases monotonically as time passes.

Trigger generation section 104 generates a trigger indicating the importance of a picture, and outputs this trigger to combining trigger calculation section 106. To be more specific, a trigger here is a signal that is issued when an image determined to be important to the user is contained in a picture input to picture combining apparatus 100, and includes a value (hereinafter referred to as “trigger value”) indicating the degree of importance.

Specifically, assuming use of this picture combining apparatus 100 in a surveillance system that monitors the presence or absence of an abnormal situation, trigger generation section 104 may comprise, for example, at least one of the following sensors:
(1) A motion detection sensor
(2) A motion recognition sensor
(3) An image recognition sensor

A motion detection sensor outputs a trigger when an area is detected in which sudden movement, such as the appearance of an intruder, for example, occurs in a picture being screenshot. In this case, the greater the movement, the larger is the trigger value, and the greater the degree of importance. This motion detection sensor may comprise an infrared sensor or the like, for example. Thus, in this case, the trigger may be, for example, alarm information indicating the existence of a preset specific situation such as an abnormal occurrence via a sensor attached to a surveillance camera or a sensor installed in the vicinity of a surveillance camera.

A motion recognition sensor outputs a trigger when an object (including a person) that exhibits motion other than normal motion registered beforehand is present in an input picture. In this case, the greater the abnormal movement, the larger is the trigger value, and the greater the degree of importance. This motion recognition sensor may comprise a camera or the like, for example. Thus, in this case, the trigger may be, for example, motion detection information that is obtained by detecting the movement of an object in a picture, and that indicates the magnitude of movement of the object.

An image recognition sensor outputs a trigger when an object registered beforehand is present in an input picture. In this case, the higher the recognition result, the larger is the trigger value, and the greater the degree of importance. This image recognition sensor may comprise an image processing apparatus or the like, for example. Thus, in this case, the trigger is an image recognition result that is obtained by image detection (by means of a method such as pattern matching, for example) of a specific object in a picture, and indicates the presence of the specific object in the picture.

When a scene determined to be important is captured in an input picture, in addition to outputting a trigger to combining trigger calculation section 106, trigger generation section 104 also outputs trigger location information indicating the trigger generation location in the picture together with the trigger.

Trigger generation section 104 is not limited to an above-described motion detection sensor, motion recognition sensor, or image recognition sensor. For example, it could be an apparatus that receives screen combining requests from the user. In this case, the trigger is a screen combining request from the user.

Also, since the criteria for determining importance within an input picture vary in accordance with the use of the system, a trigger is not limited to one originated by a sensor or user request, but may be output by any means as long as it contains the trigger generation location within a picture (trigger location) and a value indicating the degree of importance of a picture (trigger value).

Also, trigger generation sources (above-described sensors or user requests) may be used independently or in combination.

Combining trigger calculation section 106 calculates a combining trigger using a trigger from trigger generation section 104, and outputs this combining trigger to screen configuration calculation section 108. Here, a combining trigger is a signal that has two values used for calculating screen combining parameters: a trigger classification indicating the kind of importance of an input picture, and a trigger value indicating the degree of that importance.

Specifically, combining trigger calculation section 106 determines the trigger classification of a combining trigger to be one of the following, for example, in accordance with the type of trigger input from trigger generation section 104 (or the use of the system):
(1) Important screenshot (meaning that an important image is included at a specific time of the input picture)
(2) Important area (meaning that an important area is included in a specific area of the input picture)
(3) Important scene (meaning that important images are included in a specific section of the input picture)

With regard to the size of the trigger value of a combining trigger, since the size of a trigger input from trigger generation section 104—that is, the trigger value—indicates the degree of importance, the size of an input trigger is used directly.

For example, assuming the system to be a surveillance system, combining trigger calculation section 106 determines the trigger classification of a combining trigger, as follows:
1. When a trigger is generated by a motion detection sensor, an image at the time at which a suspicious intruder appears is important, and to prevent such an image being overlooked, the trigger classification is determined to be “important screenshot.”
2. When a trigger is generated by an image recognition sensor, a previously registered suspicious object, suspicious person, or the like, is important, and to perform enlargement for a highly appealing view, the trigger classification is determined to be “important area.”
3. When a trigger is generated by a motion recognition sensor, a scene containing an object or person exhibiting abnormal movement is important, and therefore the trigger classification is determined to be “important scene.”

As a result, in a surveillance system monitoring the presence or absence of an abnormal situation, triggers originated by various kinds of sensors can be converted to a trigger classification that clearly indicates the meaning of importance in a picture. Therefore, screen combining parameters can be determined so that an important scene becomes easier to see in accordance with the trigger classification indicating the importance of a picture. The determination method will be described in detail later herein.

Combining trigger calculation section 106 outputs trigger location information from trigger generation section 104 directly to screen configuration calculation section 108.

Screen configuration calculation section 108 makes a decision on screen combining using a combining trigger from combining trigger calculation section 106 (and trigger location information as necessary), and calculates the screen configuration. That is to say, using the combining trigger, screen configuration calculation section 108 determines screen combining should be performed or should not be performed, and if screen combining is to be performed, screen configuration calculation section 108 calculates screen combining parameters and outputs them to picture accumulation section 110, sub image creation section 112, image information adding section 114, and screen combining section 116. An input image from picture input section 102 is output to screen combining section 116 irrespective of the result of the determination.

For example, when an image is input from picture input section 102, screen configuration calculation section 108 receives a combining trigger and trigger location information from combining trigger calculation section 106, and stores the trigger classification and trigger value of the combining trigger in internal memory (not shown). If a combining trigger is not output from combining trigger calculation section 106, the combining-trigger trigger value is stored in internal memory as zero (0).

One of the screen combining parameters calculated by screen configuration calculation section 108 here is the combining classification. The combining classification is a parameter showing the screen combining method, and may indicate, for example, one of the followings:
(1) No combining (input image is output directly)
(2) Still picture combining (still picture sub image is combined in part of area of input image)
(3) Cut-out combining (cut-out sub image is combined in part of area of input image)
(4) Loop combining (specific scene is combined as sub image in part of area of input image)

For example, when the combining-trigger trigger value is not zero—that is, when a combining trigger is input—the combining classification is determined, as follows:
1. When the trigger classification of the combining trigger is “important screenshot,” an important image is included at the time at which the trigger is output in the input picture, and therefore the combining classification is determined to be “still picture combining.”
2. When the trigger classification of the combining trigger is “important area,” an important object or the like is included in the area in which the trigger is output in the input picture, and therefore the combining classification is determined to be “cut-out combining.”
3. When the trigger classification of the combining trigger is “important scene,” an important frames or the like are included around the time at which the trigger is output in the input picture, and therefore the combining classification is determined to be “loop combining.”

By determining the combining classification in accordance with the trigger classification of a combining trigger in this way, it is possible to combine pictures important to the user in an easy-to-see manner in a surveillance system.

The remaining screen combining parameters differ for each combining classification.

For example, when the combining classification is still picture combining, screen combining parameters calculated by screen configuration calculation section 108 in addition to combining classification may be, for instance, target sub image (a parameter indicating the image number of an image to be used in sub image creation) and sub image display time (a parameter indicating the time for which a sub image is continuously displayed when combined) (a total of three parameters).

When the combining classification is cut-out combining, screen combining parameters calculated by screen configuration calculation section 108 in addition to combining classification may be, for instance, cut-out center coordinates (a parameter indicating the center coordinates in an input image of an image to be cut out as a sub image) and cut-out size (a parameter indicating the size of an image to be cut out as a sub image) (a total of three parameters).

When the combining classification is loop combining, screen combining parameters calculated by screen configuration calculation section 108 in addition to combining classification may be, for instance, combining scene central time (a parameter indicating the image number of the item located at the central time of a scene to be combined) and playback speed (a parameter indicating the playback speed of a scene for repeated playback as a sub image) (a total of three parameters) in a first pattern (hereinafter referred to as “pattern 1”); combining scene central time and loop length (a parameter indicating the number of images forming a scene for repeated playback as a sub image) (a total of three parameters) in a second pattern (hereinafter referred to as “pattern 2”); and combining scene central time, number of loops (a parameter indicating the number of repetitions of a scene for repeated playback as a sub image), and frame counter (a parameter indicating the remaining number of images to be combined as a sub image) (a total of four parameters) in a third pattern (hereinafter referred to as “pattern 3”).

Also, when the size of a sub image is changed in accordance with the trigger value, sub image size (a parameter indicating the sub image combining size) is added as a screen combining parameter in each combining classification.

The actual method of calculating the screen combining parameters will be described in detail later herein for each combining classification.

Picture accumulation section 110 stores images output from picture input section 102 in internal memory. When storing a picture, picture accumulation section 110 determines whether or not internal memory is to be rewritten based on screen combining parameters output from screen configuration calculation section 108.

For example, when the “combining classification” screen combining parameter is “no combining,” rewriting of internal memory is performed using an input image.

When the combining classification is “still picture combining,” internal memory rewriting is not performed if the number of the “target sub image” screen combining parameter is different from the image number of the input image. Conversely, when the combining classification is “still picture combining,” internal memory rewriting is performed using the input image if the number of the “target sub image” screen combining parameter is the same as the image number of the input image.

When the combining classification is other than “no combining”—that is, “still picture combining,” cut-out combining,” or “loop combining”—picture accumulation section 110 outputs an image stored in internal memory to sub image creation section 112.

When “loop combining” can be handled as a combining classification, picture accumulation section 110 has internal memory capable of storing a plurality of images, in particular, and can store a plurality of images output from picture input section 102 in internal memory. In this case internal memory has, in addition to a memory area for storing a plurality of images, a storage counter indicating the storage location of an image, and a read counter indicating the read location of an image. The maximum value that can be held by each counter is the number of images that can be stored in internal memory, and when the counter value exceeds the maximum value after being updated, the counter value is set to 1 again. That is to say, the internal memory has a structure whereby periodic image data can be stored and read by updating counters each time image storage or reading is performed.

Sub image creation section 112 creates a sub image using an image output from picture accumulation section 110 based on screen combining parameters output from screen configuration calculation section 108.

Specifically, when, for example, the “combining classification” screen combining parameter is “still picture combining,” an image that is a sub image target output from picture accumulation section 110 is reduced to sub image size and output to image information adding section 114. Here, the sub image size is assumed to be predetermined, and not to exceed the input image size. However, the sub image size can be changed in accordance with picture contents.

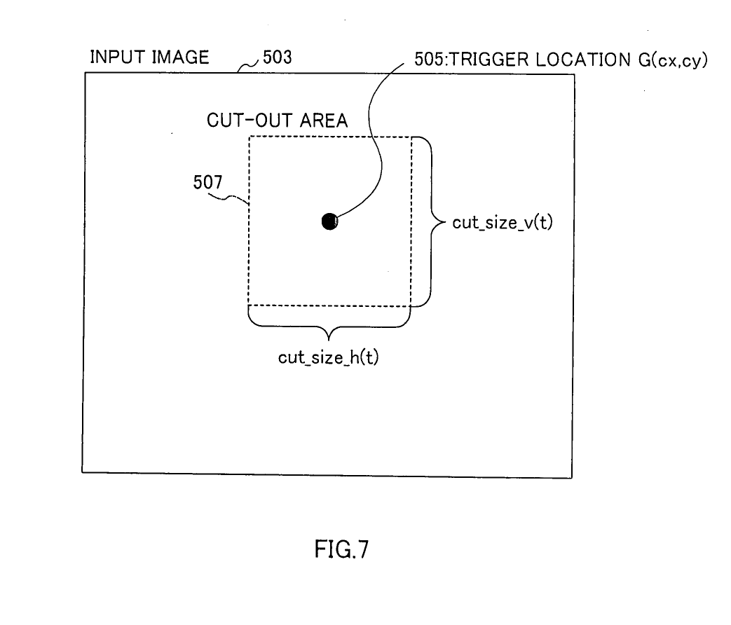

When the combining classification is “cut-out combining,” sub image cutting-out and size reduction are performed using a sub image target image output from picture accumulation section 110, and the resultant image is output to image information adding section 114. Sub image cutting-out is performed, for example, by cutting out a cut-out area (see FIG. 7 described later herein) defined by horizontal and vertical cut-out sizes, and with the “cut-out center coordinates” screen combining parameter as the center, in a sub image target image. Here, too, the sub image size is assumed to be predetermined, and not to exceed the input picture size. However, the sub image size can be changed in accordance with picture contents.

Details of sub image creation processing will be given later herein for each combining classification.

Image information adding section 114 changes the color of the border of a sub image output from sub image creation section 112 in accordance with the “combining classification” screen combining parameter output from screen configuration calculation section 108. Specifically, for example, the sub image border color may be changed to red when the combining classification is “still picture combining,” to blue when “cut-out combining,” and to yellow when “loop combining.” However, border colors corresponding to combining classifications are not limited to the above examples, and any colors may be used as long as they enable a sub image to be identified as a still picture, cut-out image, or loop playback image. A sub image whose border has been colored to indicate the combining classification is output to screen combining section 116.

As an alternative to changing the color of the border of a sub image as a method of representing the combining classification of a sub image, it is also possible to change the shape of a sub image, for example. This method will be described later herein.

Screen combining section 116 combines an image (main image) output from screen configuration calculation section 108 with a sub image output from image information adding section 114 in one screen, and outputs the image after combining (composite image) to picture coding section 300. It is here assumed that, in performing screen combining, the location at which a sub image is to be combined with the main image is predetermined, and a composite image is created by superimposing the sub image at the location at which the sub image is to be combined in the main image. It is assumed that the sub image combining location can be changed in accordance with the characteristics of the input picture, and may be any location.

A number of actual examples of the operation of a picture combining apparatus 100 with the above configuration will now be described. To simplify the descriptions, it is here assumed that picture signal generation section 200 comprises a single camera and A/D conversion section, and that only one picture is input to picture combining apparatus 100. Where necessary, the description assumes a case where this picture combining apparatus 100 is used in a surveillance system monitoring the presence or absence of an abnormal situation, for example.

### OPERATION EXAMPLE 1

In Operation Example 1, a description is given of a case in which, when screen combining is performed as the result of screen combining determination using a combining trigger, the image at the time when the trigger is generated is made a still picture, and this still picture is combined as a sub image in an area of part of the input image—that is to say, a case in which “still picture combining” is performed. It is assumed here that the larger the trigger size, the longer is the display time set.

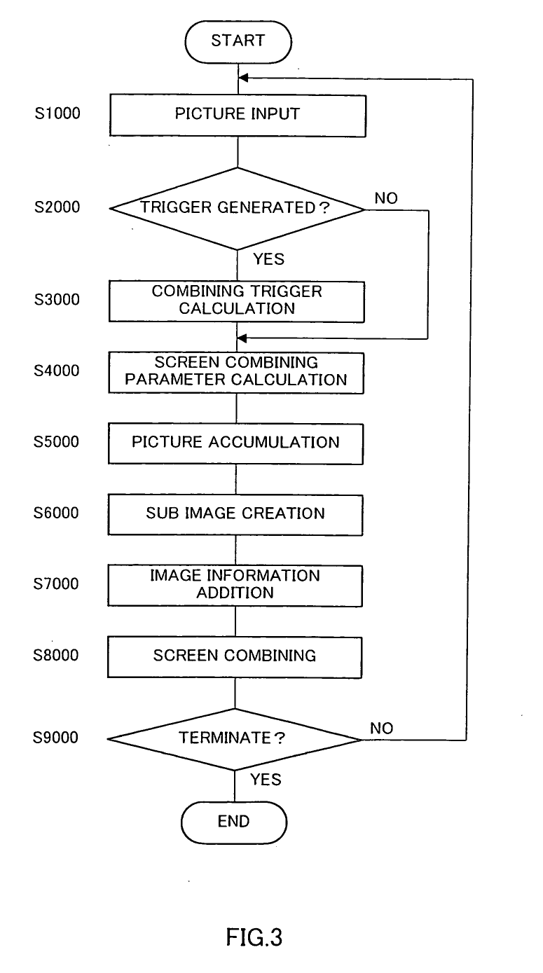

FIG. 3 is a flowchart for explaining the operation of picture combining apparatus 100 according to this embodiment.

First, in step S1000, picture input section 102 performs picture input processing that inputs a picture signal. Specifically, a synchronization signal is detected from a picture signal input from picture signal generation section 200, and images making up the picture are output to screen configuration calculation section 108 and picture accumulation section 110 on a screen-by-screen basis. At this time, an image number that is unique to an individual picture and whose value increases monotonically as time passes is added to each image output from picture input section 102.

Then, in step S2000, it is determined whether or not a trigger (including a trigger value indicating the degree of importance) has been generated by trigger generation section 104. This determination is made, for example, according to whether or not a signal (trigger) from trigger generation section 104 has been input to combining trigger calculation section 106. In the case of a surveillance system, for example, as described above, a trigger is output by a sensor such as a motion detection sensor, motion recognition sensor, or image recognition sensor. If the result of this determination is that a trigger has been generated (S2000: YES), the processing flow proceeds to step S3000, and if it is determined that a trigger has not been generated (S2000: NO), the processing flow proceeds directly to step S4000.

In step S3000, combining trigger calculation section 106 performs combining trigger calculation processing in which a trigger is input and a combining trigger is calculated. Specifically, combining trigger calculation section 106 calculates a combining trigger (including trigger classification and trigger value) using a trigger from trigger generation section 104, and outputs this combining trigger to screen configuration calculation section 108. As stated above, combining trigger calculation section 106 determines the trigger classification of the combining trigger to be, for example, (1) important screenshot, (2) important area, or (3) important scene, in accordance with the type of trigger input (or the use of the system). The input trigger size is used directly as the size of the trigger value of the combining trigger.

As described above, in the case of a surveillance system, for example, the trigger classification of the combining trigger is determined, as follows:
1. When the trigger is generated by a motion detection sensor, an image at the time at which a suspicious intruder appears is important, and to prevent such an image being overlooked, the trigger classification is determined to be “important screenshot.”
2. When the trigger is generated by an image recognition sensor, a previously registered suspicious object, suspicious person, or the like, is important, and to perform enlargement for a clearer view, the trigger classification is determined to be “important area.”
3. When the trigger is generated by a motion recognition sensor, a scene containing an object or person exhibiting abnormal movement is important, and therefore the trigger classification is determined to be “important scene.”

As “still picture combining” is performed in this operation example, the trigger classification is determined to be “important screenshot.”

Next, in step S4000, screen configuration calculation section 108 performs screen combining parameter calculation processing in which screen combining parameters are calculated. Specifically, using the combining trigger from combining trigger calculation section 106, it is first determined whether or not screen combining is to be performed, and if the result of the determination is that screen combining is to be performed, screen configuration calculation section 108 calculates screen combining parameters which it outputs to picture accumulation section 110, sub image creation section 112, image information adding section 114, and screen combining section 116. An input image from picture input section 102, on the other hand, is output to screen combining section 116 irrespective of the result of determination as to whether or not screen combining is to be performed.

As described above, when an image is input from picture input section 102, for example, a combining trigger from combining trigger calculation section 106 is received, and the trigger classification and trigger value of the combining trigger are stored in internal memory. If a combining trigger is not output from combining trigger calculation section 106, the combining-trigger trigger value is stored in internal memory as zero (0). Then determination as to screen combining is performed according to whether or not the combining-trigger trigger value is zero—that is, whether or not there is combining trigger input. Also, screen combining parameters such as the combining classification are determined based on the combining-trigger trigger classification.

As “still picture combining” is performed in this operation example, three items are calculated as screen combining parameters: combining classification (here, “still picture combining”), target sub image, and sub image display time. Here, “target sub image” is a parameter indicating the image number of an image to be used in sub image creation, as described above, and “sub image display time” is a parameter indicating the time for which a sub image is continuously displayed when combined, as described above.

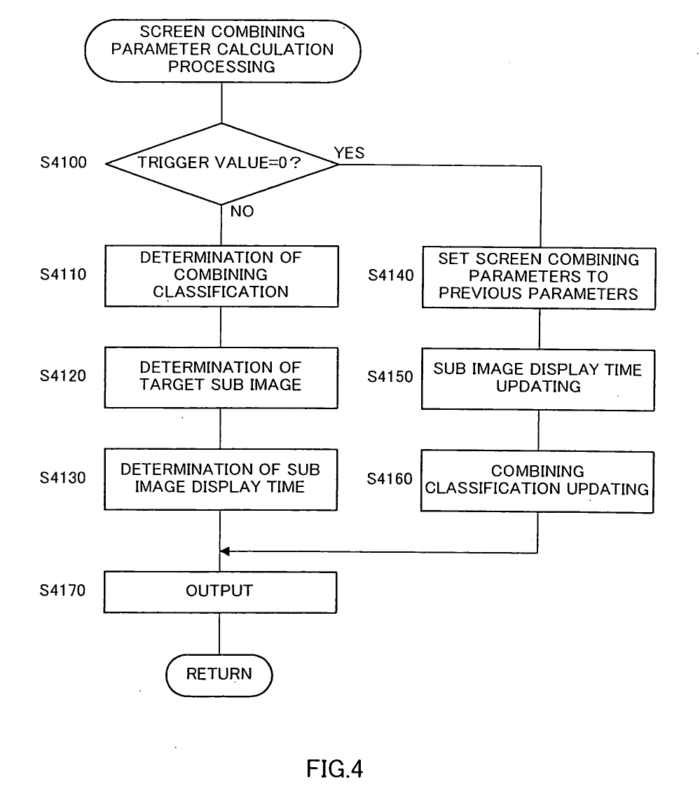

FIG. 4 is a flowchart showing the contents in Operation Example 1 of screen combining parameter calculation processing in FIG. 3.

First, in step S4100, it is determined whether or not the combining-trigger trigger value is zero—that is, whether or not there is combining trigger input. If the result of this determination is that the combining-trigger trigger value is not zero—that is, that there is combining trigger input—(S4100: NO), the processing flow proceeds to step S4110, and if it is determined that the combining-trigger trigger value is zero—that is, that there is no combining trigger input—(S4100: YES), the processing flow proceeds to step S4140.

In step S4110, since the combining-trigger trigger value is not zero—that is, there is combining trigger input—the combining classification is determined in accordance with predetermined criteria. For example, as described above:
1. When the trigger classification of the combining trigger is “important screenshot,” an important image is included at the time at which the trigger is output in the input picture, and therefore the combining classification is determined to be “still picture combining.”
2. When the trigger classification of the combining trigger is “important area,” an important object or the like is included in the area in which the trigger is output in the input picture, and therefore the combining classification is determined to be “cut-out combining.”
3. When the trigger classification of the combining trigger is “important scene,” an important scene or the like is included around the time at which the trigger is output in the input picture, and therefore the combining classification is determined to be “loop combining.”

As the trigger classification is “important screenshot” in this operation example, the combining classification is determined to be “still picture combining.”

Next, in step S4120, the target sub image is determined. Here, the current input image is determined as the target sub image.

Then, in step S4130, the sub image display time is determined. Specifically, the sub image continuous display time is calculated based on the size of the trigger value. For example, sub image display time time_disp(t) is calculated using Expression (1) below.

$$time\_disp ( t ) = \frac{Trigger ( t )}{MAX\_Trigger} * MAX\_time \qquad Expression ( 1 )$$

time_disp(t): Display time of sub image at time t

Trigger(t): Trigger value at time t

MAX_Trigger: Maximum value possible as trigger value

MAX_time: Maximum setting value for sub image display time

As shown in Expression (1), the sub image continuous display time increases as the size of the trigger value increases.

Expression (1) is only a sample calculation method, and calculation is not restricted to this method. Any sub image display time calculation method may be used whereby the display time increases as the size of the trigger value increases.

In step S4140, on the other hand, since the combining-trigger trigger value is zero—that is, there is no combining trigger input—screen combining parameters are set to the parameters used at the time of the previous calculation.

Then, in step S4150, the sub image continuous display time is updated. For example, sub image display time time_disp(t) is updated using Expression (2) below.
time_{—}disp(T)=time_{—}disp(t)−(T−t) Expression (2)

T : Current time

t: Time at which previous screen combining parameters were calculated

That is to say, as shown in Expression (2), the sub image display time is updated by subtracting the elapsed time from the time at which the previous screen combining parameters were calculated up to the present from the sub image display time at the time of the previous calculation.

Next, in step S4160, updating of the combining classification is carried out. Specifically, if the sub image display time has become zero or less as a result of the sub image display time update processing in step S4150, the combining classification is changed to “no combining.”

In step S4170, the three screen combining parameters (combining classification, target sub image, and sub image display time) calculated in step S4100 through step S4160 are output to picture accumulation section 110, sub image creation section 112, image information adding section 114, and screen combining section 116, the input picture (input image from picture input section 102) is output to screen combining section 116, and then the process returns to the main flowchart in FIG. 3.

Then, in step S5000, picture accumulation section 110 carries out picture accumulation processing in which picture accumulation is performed. Specifically, an image output from picture input section 102 is stored in internal memory. At this time, whether or not internal memory is to be rewritten is determined based on screen combining parameters from screen configuration calculation section 108. For example, when the “combining classification” screen combining parameter is “no combining,” internal memory rewriting is performed using an input image. When the combining classification is “still picture combining,” internal memory rewriting is not performed if the number of the “target sub image” screen combining parameter is different from the image number of the input image. However, when the combining classification is “still picture combining,” internal memory rewriting is performed using the input image if the number of the “target sub image” screen combining parameter is the same as the image number of the input image.

As “still picture combining” is performed in this operation example, an image stored in internal memory is output to sub image creation section 112.

Next, in step S6000, sub image creation section 112 performs sub image creation processing in which a sub image to be used in screen combining is created. Specifically, a sub image is created using an image output from picture accumulation section 110 based on screen combining parameters output from screen configuration calculation section 108, and the created sub image is output to image information adding section 114.

When “still picture combining” is performed as in this operation example, for example, an image that is a sub image target output from picture accumulation section 110 is reduced to sub image size and output to image information adding section 114. Here, as stated above, the sub image size is assumed to be predetermined, and not to exceed the input image size. However, the sub image size can be changed in accordance with picture contents.

Then, in step S7000, image information adding section 114 performs image information adding processing in which sub image picture information is added. Specifically, for example, the color of the border of a sub image output from sub image creation section 112 is changed in accordance with the “combining classification” screen combining parameter output from screen configuration calculation section 108, and a sub image whose border color has been changed is output to screen combining section 116.

When the combining classification is “still picture combining” as in this operation example, for example, the sub image border color is changed to red. However, the border color is not limited to red, and any color may be used as long as it enables the sub image to be identified as a still picture.

Next, in step S8000, screen combining section 116 performs screen combining processing in which images are combined in one screen. Specifically, screen combining section 116 combines an image (main image) output from screen configuration calculation section 108 with a sub image output from image information adding section 114 in one screen, and outputs the image resulting from combining (composite image) to picture coding section 300. As stated above, in performing screen combining, the location at which a sub image is to be combined with the main image is predetermined, and a composite image is created by superimposing the sub image at the location at which the sub image is to be combined in the main image. The sub image combining location can be changed in accordance with the characteristics of the input picture.

Then, in step S9000, it is determined whether or not the series of picture combining processes from step S1000 through step S8000 is to be terminated. This determination is made based on whether or not a preset time or number of frames has been exceeded, or whether or not a termination request has been made by the user, for example. If it is determined that a preset time or number of frames has been exceeded, or a termination request has been made by the user, (S9000: YES), the above-mentioned series of picture combining processes is terminated, and if it is determined otherwise (S9000: NO), the processing flow returns to step S1000.

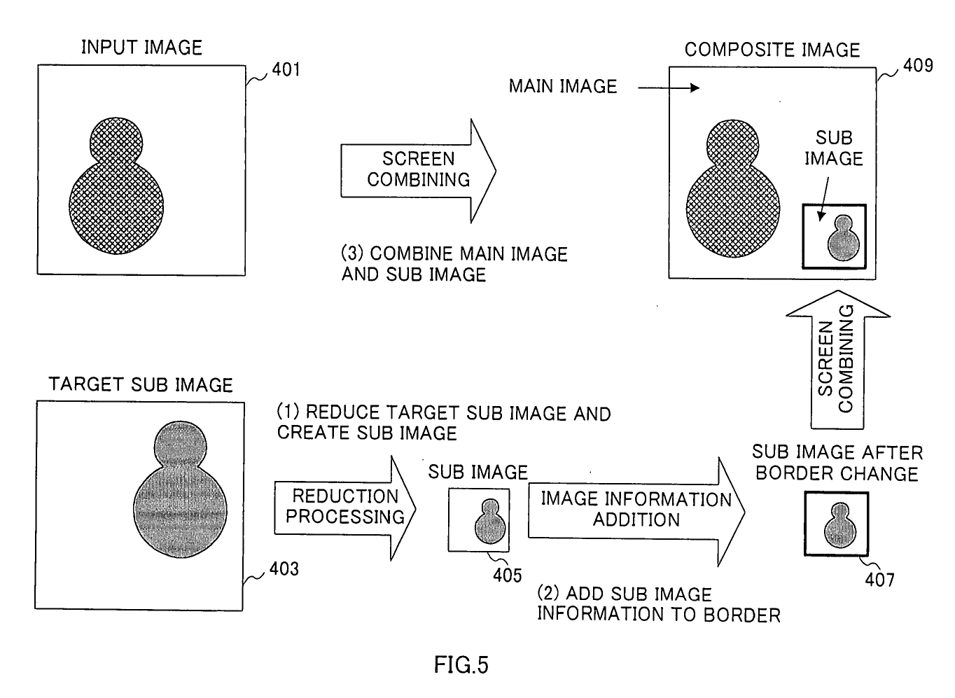

FIG. 5 is an explanatory drawing showing an overview of screen combining by means of above-described “still picture combining.”

In FIG. 5, reference numeral 401 denotes a current input image, 403 a target sub image to be reduced in size, 405 a sub image created by reducing target sub image 403, 407 a sub image in which sub image 405 image information (combining classification) is represented by the border color, and 409 a composite image in which input image 401 and sub image 407 whose border has been changed are combined by superimposition.

In this way, when still picture combining is performed, the input image and an image of the time a trigger is generated (reduced image) can be displayed simultaneously within composite image 409, as shown in FIG. 5. Moreover, the sub image status (classification: here, “still picture combining”) can be indicated by the color of the border of the sub image.

Thus, according to this operation example, image combining is performed with control executed so that the larger the value of a trigger indicating the importance of a picture, the longer is the time for which a picture at the time of trigger generation is displayed as a still picture, and therefore by coding a combined picture, transmitting it via a transmission path, and displaying it on a receiving terminal, a user can not only view the current picture, but also simultaneously view a picture of an important time as a still picture, on a receiving terminal that has only one screen, and moreover can view a picture for longer the more important it is.

Also, if the correspondence between border colors and sub image contents is known, the user can determine sub image contents from the border color of a sub image without transmitting or receiving information other than a composite image. That is to say, in a conventional system, a plurality of pictures are simply reduced and combined, and simply reduced and combined pictures do not include additional information indicating the status of individual pictures, etc., so that it is necessary to transmit/receive and display additional information apart from pictures in order to learn additional information on individual pictures, making the system complex, whereas the present invention enables this disadvantage to be remedied.

In this operation example, an example has been shown in which an input image is displayed as the main image and a still picture as a sub image, but this is not a limitation, and it is also possible to display a still picture as the main image and an input image as a sub screen.

Furthermore, the number of input pictures is not limited to one, and still picture combining is also possible in the case of a plurality of input pictures.

### OPERATION EXAMPLE 2

In Operation Example 2, a description is given of a case in which, when screen combining is performed as the result of screen combining determination using a combining trigger, an area is cut out centered on the location at which a trigger is generated in the image area, and the image of this cut-out area is combined as a sub image in an area of part of the input image—that is to say, a case in which “cut-out combining” is performed. It is assumed here that the larger the trigger size, the smaller is the cut-out size set.

The description here refers to FIG. 3, focusing on parts where processing differs from that in Operation Example 1.

The processing in step S1000 through step S3000 is the same as in Operation Example 1, and therefore a description thereof is omitted here. However, although not alluded to in Operation Example 1, when a scene deemed to be important is screenshot in an input image, trigger location information indicating the trigger generation location in the screen is output together with a trigger (including a trigger value indicating the degree of importance) from trigger generation section 104 to combining trigger calculation section 106, as described above. Trigger location information input to combining trigger calculation section 106 is output to screen configuration calculation section 108 together with a combining trigger.

As “cut-out combining” is performed in this operation example, the trigger classification is determined to be “important area” in the combining trigger calculation processing in step S3000.

Then screen combining parameter calculation processing is performed in step S4000, in the same way as in Operation Example 1. Here, however, when an image is input from picture input section 102, a combining trigger and trigger location information from combining trigger calculation section 106 are received, and the combining-trigger trigger classification and trigger value, together with the trigger location of the trigger, are stored in internal memory.

As “cut-out combining” is performed in this operation example, three items are calculated as screen combining parameters: combining classification (here, “cut-out combining”), cut-out center coordinates, and cut-out size. Here, “cut-out center coordinates” is a parameter indicating the center coordinates in an input image of an image to be cut out as a sub image, as described above, and “cut-out size” is a parameter indicating the size of an image to be cut out as a sub image, as described above.

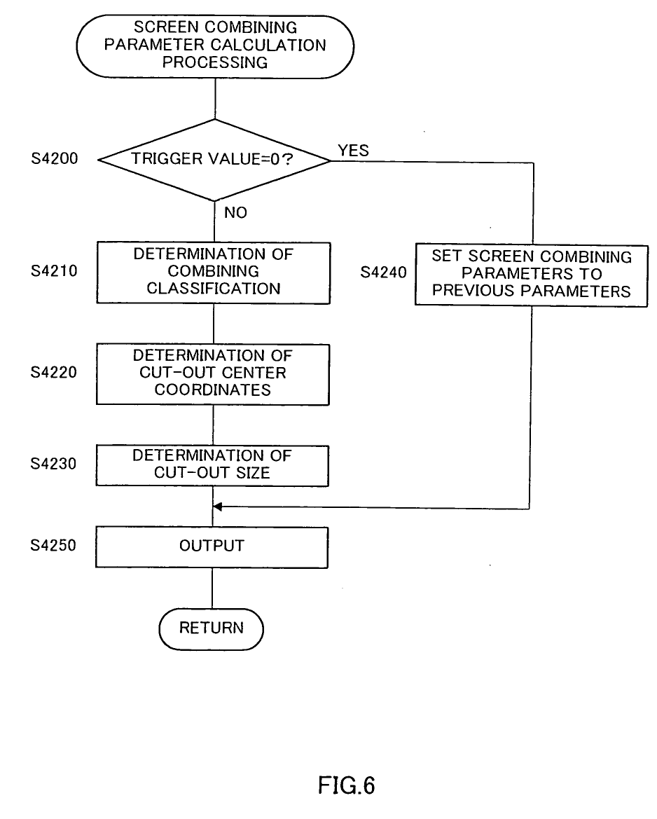

FIG. 6 is a flowchart showing the contents in Operation Example 2 of screen combining parameter calculation processing in FIG. 3. Processing common to Operation Example 1 shown in FIG. 4 will only be briefly described.

First, in step S4200, it is determined whether or not the combining-trigger trigger value is zero—that is, whether or not there is combining trigger input—in the same way as in Operation Example 1 (see step S4100 in FIG. 4). If the result of this determination is that the combining-trigger trigger value is not zero—that is, that there is combining trigger input—(S4200: NO), the processing flow proceeds to step S4210, and if it is determined that the combining-trigger trigger value is zero—that is, that there is no combining trigger input—(S4200: YES), the processing flow proceeds to step S4240.

In step S4210, since the combining-trigger trigger value is not zero—that is, there is combining trigger input—the combining classification is determined in accordance with predetermined criteria in the same way as in Operation Example 1 (see step S4110 in FIG. 4). In this operation example the trigger classification is “important area” and an important object or the like is included in the area in which the trigger is output in the input picture, and therefore the combining classification is determined to be “cut-out combining.”

Next, in step S4220, the cut-out center coordinates are determined. Here, the cut-out center coordinates are determined as the trigger location.

Then, in step S4230, the cut-out size is determined. Specifically, the sub image cut-out size is calculated based on the size of the trigger value. For example, sub image horizontal cut-out size cut_size_h(t) and vertical cut-out size cut_size_v(t) are calculated using Expression (3) and Expression (4) below, respectively.

$$\begin{matrix}cut\_size \_h ( t ) = \frac{MAX\_Trigger}{Trigger ( t )} * MIN\_size \_h & Expression ( 3 ) \\ cut\_size \_v ( t ) = \frac{MAX\_Trigger}{Trigger ( t )} * MIN\_size \_v & Expression ( 4 )\end{matrix}$$

cut_size_h(t): Horizontal cut-out size of sub image at time t

cut_size_v(t): Vertical cut-out size of sub image at time t

Trigger(t): Trigger value at time t

MAX_Trigger: Maximum value possible as trigger value

MIN_size_h: Minimum horizontal setting value for sub image cut-out size

MIN_size_v: Minimum vertical setting value for sub image cut-out size

As shown in Expression (3) and Expression (4), the sub image cut-out size decreases as the size of the trigger value increases. It is assumed that the cut-out size does not exceed the size of an input image.

FIG. 7 is an explanatory drawing of this cut-out area calculation method. In FIG. 7, reference numeral 503 denotes an input image that is a sub image target, 505 the trigger location (here equivalent to the cut-out center coordinates), and 507 the cut-out area defined by the cut-out size calculated based on the trigger value.

Expression (3) and Expression (4) are only sample calculation methods, and calculation is not restricted to these methods. Any cut-out size calculation method may be used whereby the size decreases as the size of the trigger value increases.

In step S4240, on the other hand, since the combining-trigger trigger value is zero—that is, there is no combining trigger input—screen combining parameters are set to the parameters used at the time of the previous calculation.

In step S4250, the three screen combining parameters (combining classification, cut-out center coordinates, and cut-out size) calculated in step S4200 through step S4240 are output to picture accumulation section 110, sub image creation section 112, image information adding section 114, and screen combining section 116, the input picture (input image from picture input section 102) is output to screen combining section 116, and then the process returns to the main flowchart in FIG. 3.

Then, in step S5000, an image output from picture input section 102 is stored in internal memory, in the same way as in Operation Example 1. As “cut-out combining” is performed in this operation example, an image stored in internal memory is output to sub image creation section 112.

Next, in step S6000, as in Operation Example 1, a sub image is created using an image output from picture accumulation section 110 based on screen combining parameters output from screen configuration calculation section 108, and the created sub image is output to image information adding section 114.

When “cut-out combining” is performed as in this operation example, sub image cutting-out and size enlargement/reduction are performed using an image that is a sub image target output from picture accumulation section 110, and the result is output to image information adding section 114. As shown in FIG. 7, a sub image cut-out operation is performed by cutting out cut-out area 507 defined by horizontal and vertical cut-out sizes cut_size_h(t) and cut_size_v(t), with “cut-out center coordinates” screen combining parameter G(cx,cy) (equivalent to trigger location 505) as the center, in sub image target input image 503.

Here, as stated above, the sub image size is assumed to be predetermined, and not to exceed the input image size. However, the sub image size can be changed in accordance with picture contents.

Then, in step S7000, as in Operation Example 1, the color of the border of a sub image output from sub image creation section 112 is changed in accordance with the “combining classification” screen combining parameter output from screen configuration calculation section 108, and a sub image whose border color has been changed is output to screen combining section 116.

When the combining classification is “cut-out combining” as in this operation example, the sub image border color is changed to blue. However, the border color is not limited to blue, and any color may be used as long as it enables the sub image to be identified as a cut-out image.

The processing in step S8000 and step S9000 is the same as in Operation Example 1, and therefore a description thereof is omitted here.

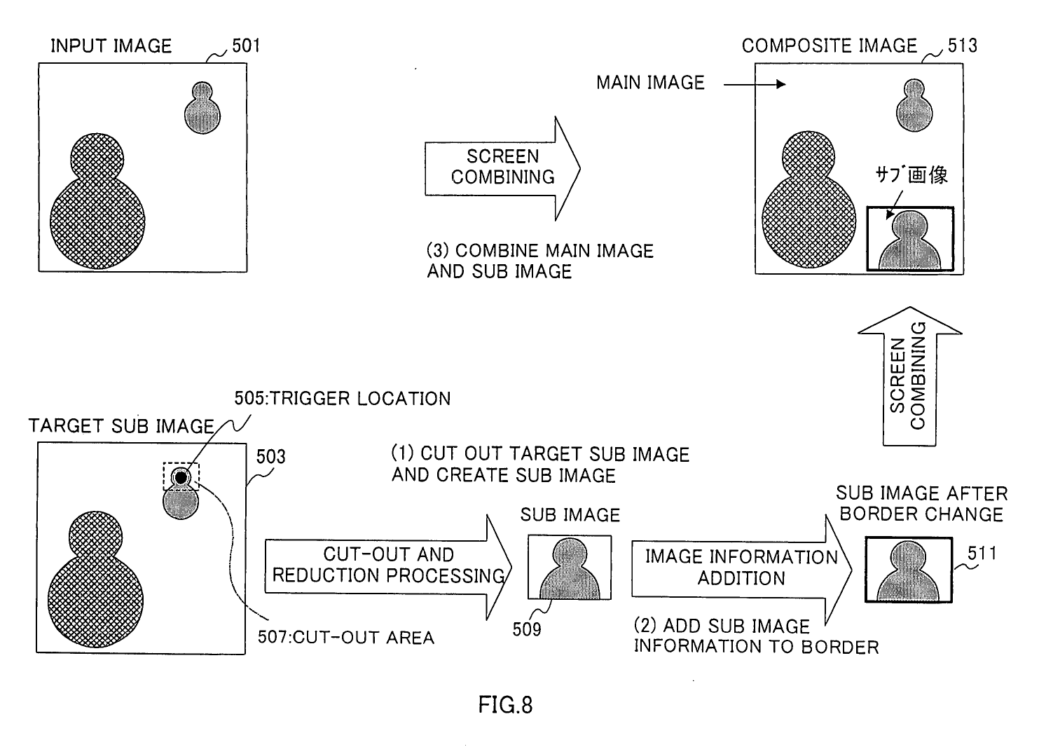

FIG. 8 is an explanatory drawing showing an overview of screen combining by means of above-described cut-out combining.

In FIG. 8, reference numeral 501 denotes a current input image, 503 a target sub image to be cut out, 505 the trigger location in an image in which a trigger is generated, 507 a cut-out area indicating an area to be cutout, 509 a sub image created by cutting out and reducing the size of target sub image 503, 511 a sub image in which sub image 509 image information (combining classification) is represented by the border color, and 513 a composite image in which input image 501 and sub image 511 whose border has been changed are combined by superimposition.

In this way, when cut-out combining is performed, the input image and an image cut out with the location at which a trigger is generated as the center, and enlarged or reduced, can be displayed simultaneously within composite image 513, as shown in FIG. 8. Moreover, the sub image status (classification: here, “cut-out combining”) can be indicated by the color of the border of the sub image.

Thus, according to this operation example, cut-out image combining is performed with control executed so that the larger the value of a trigger indicating the importance of a picture, the smaller is the cut-out size of an area with a trigger generation location at its center, and therefore by coding a combined picture, transmitting it via a transmission path, and displaying it on a receiving terminal, a user can not only view the current picture, but also simultaneously view a picture of an important location, cut out and enlarged or reduced, on a receiving terminal that has only one screen, and moreover can view an image of an important location more greatly enlarged the more important the picture is.

Also, if the correspondence between border colors and sub image contents is known, the user can determine sub image contents from the border color of a sub image without transmitting or receiving information other than a composite image.

In this operation example, an example has been shown in which an input image is displayed as the main image and a cut-out image as a sub image, but this is not a limitation, and it is also possible to display a cut-out image as the main image and an input image as a sub screen.

Furthermore, the number of input pictures is not limited to one, and cut-out combining is also possible in the case of a plurality of input pictures.

### OPERATION EXAMPLE 3

In Operation Example 3, a description is given of a case in which, when screen combining is performed as the result of screen combining determination using a combining trigger, a scene comprising preceding and succeeding images centered on a time at which a trigger is generated is combined as a sub image in an area of part of the input image so that that scene is played back repeatedly—that is to say, a case in which “loop combining” is performed. It is assumed here that, in “loop combining,” the larger the trigger size, the slower is the playback speed set for the scene to be played back repeatedly (pattern 1).

The description here refers to FIG. 3, focusing on parts where processing differs from that in Operation Example 1.

The processing in step S1000 through step S3000 is the same as in Operation Example 1, and therefore a description thereof is omitted here. However, as “loop combining” is performed in this operation example, the trigger classification is determined to be “important scene” in the combining trigger calculation processing in step S3000.

Then, in step S4000, using a combining trigger, screen combining determination and screen configuration calculation are performed, and screen combining parameters are calculated, in the same way as in Operation Example 1. As “loop combining” pattern 1 is performed in this operation example, three items are calculated as screen combining parameters: combining classification (here, “loop combining”), combining scene central time, and playback speed. Here, “combining scene central time” is a parameter indicating the image number of an image located at the central time of a scene to be combined, as described above, and “playback speed” is a parameter indicating the playback speed of a scene to be played back repeatedly as a sub image.

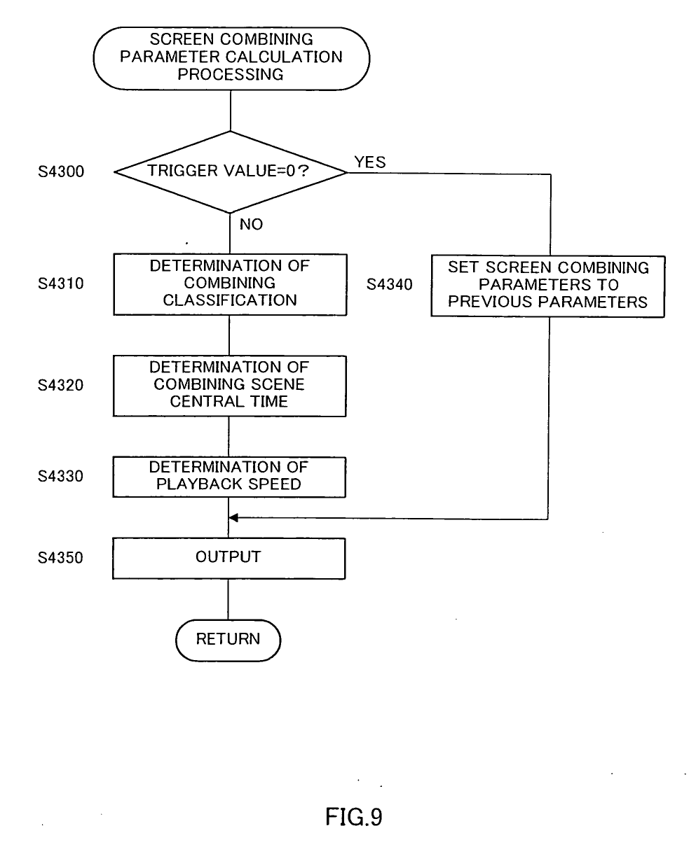

FIG. 9 is a flowchart showing the contents in Operation Example 3 of screen combining parameter calculation processing in FIG. 3. Processing common to Operation Example 1 shown in FIG. 4 will only be briefly described.

First, in step S4300, it is determined whether or not the combining-trigger trigger value is zero—that is, whether or not there is combining trigger input—in the same way as in Operation Example 1 (see step S4100 in FIG. 4). If the result of this determination is that the combining-trigger trigger value is not zero—that is, that there is combining trigger input—(S4300: NO), the processing flow proceeds to step S4310, and if it is determined that the combining-trigger trigger value is zero—that is, that there is no combining trigger input—(S4300: YES), the processing flow proceeds to step S4340.

In step S4310, since the combining-trigger trigger value is not zero—that is, there is combining trigger input—the combining classification is determined in accordance with predetermined criteria in the same way as in Operation Example 1 (see step S4110 in FIG. 4). In this operation example the trigger classification is “important scene” and an important scene is included around the time at which the trigger is output in the input picture, and therefore the combining classification is determined to be “loop combining.”

Next, in step S4320, the combining scene central time is determined. Here, the image number of the current input frame is determined as the combining scene central time.

Then, in step S4330, the playback speed is determined. Specifically, the sub image playback speed is calculated based on the size of the trigger value. For example, sub image playback speed fps(t) is calculated using Expression (5) below.

$$fps ( t ) = \frac{MAX\_Trigger}{Trigger ( t )} * MIN\_fps \qquad Expression ( 5 )$$

fps(t): Sub image playback speed at time t

Trigger(t): Trigger value at time t

MAX_Trigger: Maximum value possible as trigger value

MIN_fps: Minimum setting value for sub image playback speed

As shown in Expression (5), the sub image playback speed decreases as the size of the trigger value increases.

Expression (5) is only a sample calculation method, and calculation is not restricted to this method. Any playback speed calculation method may be used whereby the playback speed decreases as the size of the trigger value increases.

In step S4340, on the other hand, since the combining-trigger trigger value is zero—that is, there is no combining trigger input—screen combining parameters are set to the parameters used at the time of the previous calculation.

In step S4350, the three screen combining parameters (combining classification, combining scene central time, and playback speed) calculated in step S4300 through step S4340 are output to picture accumulation section 110, sub image creation section 112, image information adding section 114, and screen combining section 116, the input picture (input image from picture input section 102) is output to screen combining section 116, and then the main flowchart in FIG. 3 is returned to.

Then, in step S5000, picture accumulation section 110 carries out picture accumulation processing. Although not alluded to in Operation Example 1, as described above, picture accumulation section 110 has internal memory capable of storing a plurality of images, and stores images output from picture input section 102 in this internal memory. This internal memory has, in addition to a memory are a for storing a plurality of images, a storage counter indicating the storage location of an image, and a read counter indicating the read location of an image, and has a structure whereby periodic image data can be stored and read by updating counters each time image storage or reading is performed.

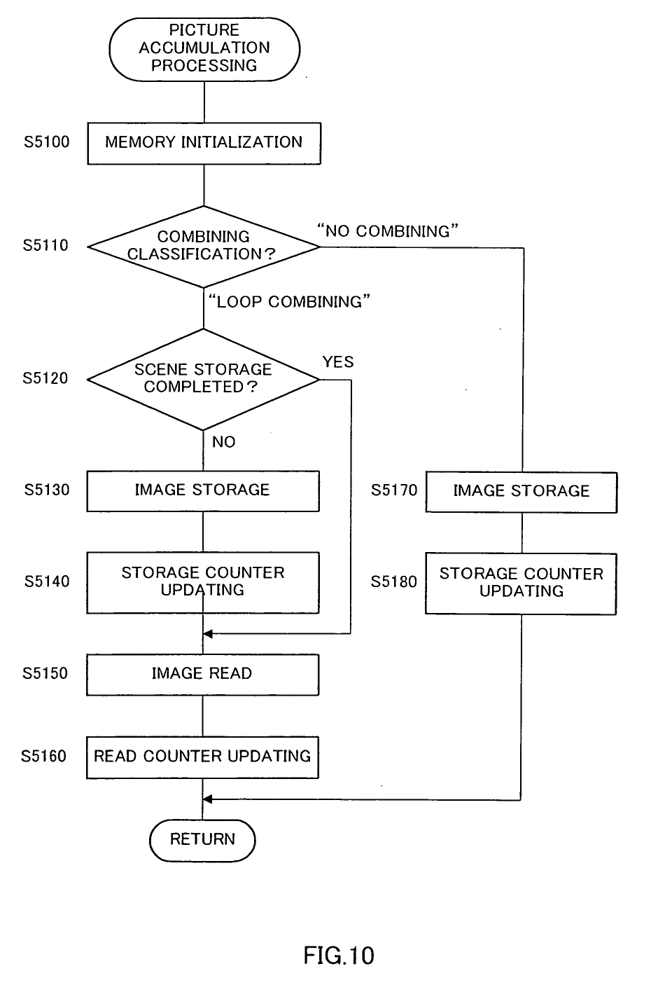

FIG. 10 is a flowchart showing the contents in Operation Example 3 of picture accumulation processing in FIG. 3.

First, in step S5100, memory initialization is performed. Specifically, the “combining scene central time” screen combining parameter and the previously input combining scene central time are compared, and if the two are different, initialization of the image data and counters in the internal memory is carried out. In this initialization, image data in internal memory is cleared, the counter values are reset to 1, and the current combining scene central time is stored in internal memory.

Then, in step S5110, it is determined whether the combining classification is “loop combining” or “no combining.” If the combining classification is determined to be “loop combining,” the processing flow proceeds to step S5120, and if the combining classification is determined to be “no combining,” the processing flow proceeds to step S5170.

In step S5120, it is determined whether or not scene storage has been completed. If it is determined that scene storage has been completed (S5120: YES), the processing flow proceeds directly to step S5150, and if it is determined that scene storage has not been completed (S5120: NO), the processing flow proceeds to step S51350.

Here, whether or not scene storage has been completed is determined using Expression (6) below.
if(count_write(t)>center_position+roop_mergin) Expression (6)

count_write(t): Storage counter value at time t

center_position: Counter value indicating location at which combining scene central time image is stored in internal memory

roop_mergin: Counter value difference from combining scene central time to image immediately after scene to be stored

Specifically, scene storage is determined to have been completed if the proposition in Expression (6) is true.

In this operation example, it is assumed that, as the configuration of images within a scene to be stored, the ratio of the number of images before and after the trigger generation time is determined beforehand. That is to say, it is assumed that the number of images from the combining scene central time to the end of the scene to be stored is determined beforehand, and the size of internal memory is determined in accordance with the number of images in the scene to be stored. Therefore, the size of internal memory determines the number of images of a scene to be played back repeatedly—that is, the scene length.

In step S5130, image storage is performed. Specifically, an input image is stored at a location indicated by a storage counter in internal memory.

Then, in step S5140, storage counter updating is performed. Specifically, update processing is performed by incrementing the storage counter value by 1. If the storage counter value exceeds the maximum value, the counter value is set to 1.

Next, in step S5150, image reading is performed. Specifically, the image at the internal memory read counter location is read, and output to sub image creation section 112.

Then, in step S5160, read counter updating is performed. Specifically, the read counter value is updated using Expression (7) or Expression (8) below, for example.

$$\begin{matrix}if ( fps \geq fps ( t ) ) \\ count\_read ( t ) = count\_read ( t - 1 ) + 1 if ( ( t mod ( \frac{fps}{fps ( t )} ) = 0 ) \\ count\_read ( t ) = count\_read ( t - 1 ) else & Expression ( 7 ) \\ if ( fps < fps ( t ) ) \\ count\_read ( t ) = count\_read ( t - 1 ) + ( \frac{fps ( t )}{fps} ) & Expression ( 8 )\end{matrix}$$

t: current time

count_read(t): Read counter value at time t

fps(t): Sub image playback speed at time t

fps: Main image playback speed

A mod B: Remainder when A is divided by B

If the read counter value exceeds the maximum value, the counter value is set to 1.

As shown in Expression (7) and Expression (8), the read counter update method is determined in accordance with the ratio between the sub image playback speed and the main image playback speed. That is to say, with Expression (7), the lower the sub image playback speed, the lower is the frequency of incrementing of the read counter value, resulting in slow playback. Conversely, with Expression (8), the higher the sub image playback speed, the higher is the frequency of incrementing of the read counter value, resulting in fast playback.

Thus, the sub image playback speed can be changed by controlling the read counter update method. When this read counter update processing ends, the flowchart in FIG. 3 is returned to.

In step S5170, on the other hand, image storage is performed. Specifically, an input image is stored at a location indicated by a storage counter in internal memory.

Then, in step S5180, storage counter updating is performed. Specifically, update processing is performed by incrementing the storage counter value by 1. If the storage counter value exceeds the maximum value, the counter value is set to 1. When this storage counter update processing ends, the flowchart in FIG. 3 is returned to.

Next, in step S6000, as in Operation Example 1, a sub image is created using an image output from picture accumulation section 110 based on screen combining parameters output from screen configuration calculation section 108, and the created sub image is output to image information adding section 114.

When “loop combining” pattern 1 is performed as in this operation example, an image that is a sub image target output from picture accumulation section 110 and obtained by means of the read counter controlled in accordance with the playback speed is reduced in size to create a sub image.

Then, in step S7000, as in Operation Example 1, the color of the border of a sub image output from sub image creation section 112 is changed in accordance with the “combining classification” screen combining parameter output from screen configuration calculation section 108, and a sub image whose border color has been changed is output to screen combining section 116.

When the combining classification is “loop combining” as in this operation example, the sub image border color is changed to yellow. However, the border color is not limited to yellow, and any color may be used as long as it enables the sub image to be identified as a loop playback image.

The processing in step S8000 and step S9000 is the same as in Operation Example 1, and therefore a description thereof is omitted here.

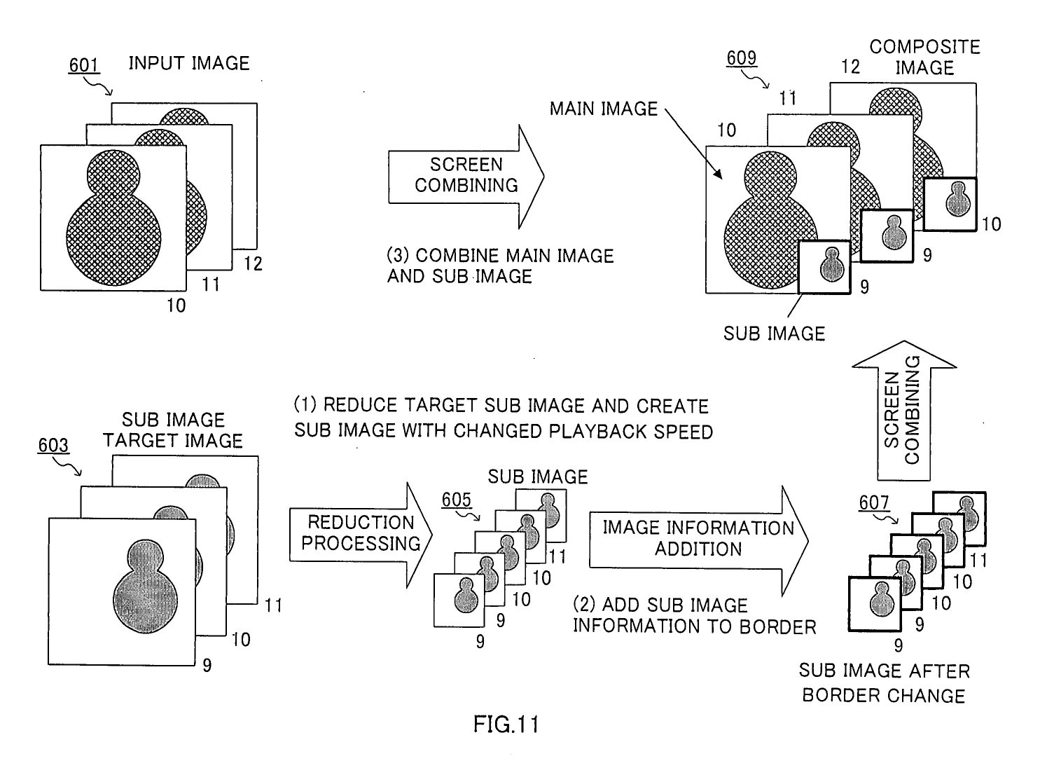

FIG. 11 is an explanatory drawing showing an overview of screen combining by means of above-described loop combining.

In FIG. 11, reference numeral 601 denotes input images with image numbers indicated by the numbers at the bottom right, 603 images of a scene stored in internal memory, 605 sub images created by reducing images obtained by means of a read counter controlled in accordance with the playback speed, 607 sub images in which the classification of sub images 605 is represented by the border color of sub images 605, and 609 composite images in which input images 601 and sub images 607 whose borders have been changed are combined. In FIG. 11, a case is illustrated in which the sub image loop playback speed is made half the main image playback speed, and sub images in the composite images have a longer image update interval than the main image, and are played back slowly.

Thus, according to this operation example, image combining is performed with control executed so that the larger the value of a trigger indicating the importance of a picture, the lower is the playback speed when a scene comprising images around a trigger generation time is played back repeatedly, and therefore by coding a combined picture, transmitting it via a transmission path, and displaying it on a receiving terminal, a user can not only view the current picture, but also simultaneously view a scene around an important time as a composite screen on a receiving terminal that has only one screen, and moreover can view a scene at a lower playback speed and taking a longer time the more important the scene is.

Also, if the correspondence between border colors and sub image contents is known, the user can determine sub image contents from the border color of a sub image without transmitting or receiving information other than a composite picture.

In this operation example, an example has been shown in which an input image is displayed as the main image and an important scene as sub images, but this is not a limitation, and it is also possible to display an important scene as the main image and an input picture as a sub screen.

Furthermore, the number of input pictures is not limited to one, and loop combining is also possible in the case of a plurality of input pictures.

### OPERATION EXAMPLE 4

In Operation Example 4, a description is given of a case in which, when screen combining is performed as the result of screen combining determination using a combining trigger, a scene comprising images around a time at which a trigger is generated is combined as a sub image in an area of part of the input image so that that scene is played back repeatedly—that is to say, a case in which “loop combining” is performed. It is assumed here that, unlike the case in Operation Example 3, in “loop combining,” the larger the trigger size, the greater is the set number of images in the scene to be played back repeatedly (pattern 2).

The description here refers to FIG. 3, focusing on parts where processing differs from that in Operation Example 1.

The processing in step S1000 through step S3000 is the same as in Operation Example 1, and therefore a description thereof is omitted here. However, as “loop combining” is performed in this operation example, the trigger classification is determined to be “important scene” in the combining trigger calculation processing in step S3000.

Then, in step S4000, using a combining trigger, screen combining determination and screen configuration calculation are performed, and screen combining parameters are calculated, in the same way as in Operation Example 1. As “loop combining” pattern 2 is performed in this operation example, three items are calculated as screen combining parameters: combining classification (here, “loop combining”), combining scene central time, and loop length. Here, “combining scene central time” is a parameter indicating the image number of an image located at the central time of a scene to be combined, as described above, and “loop length” is a parameter indicating the number of images forming a scene to be played back repeatedly as a sub image, as described above.

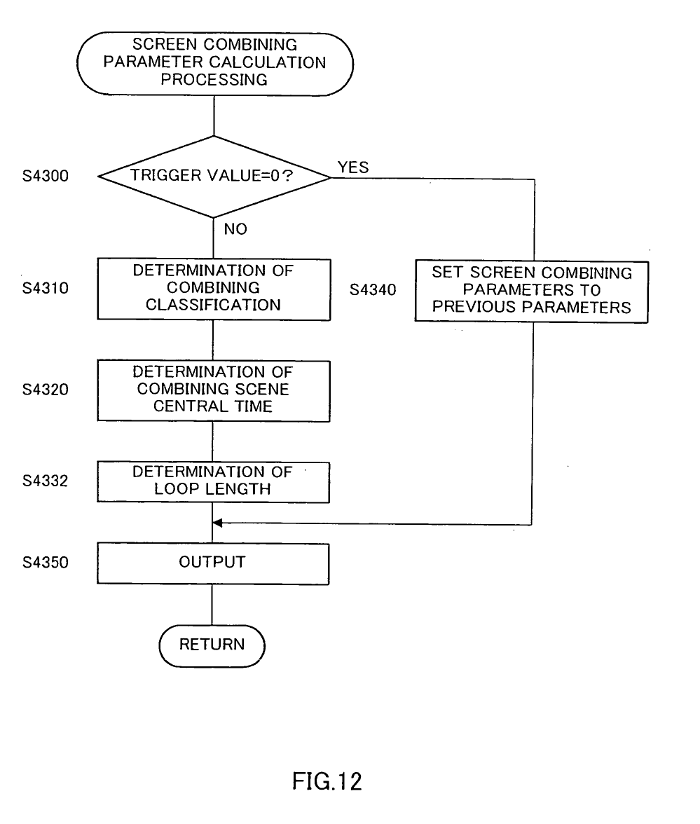

FIG. 12 is a flowchart showing the contents in Operation Example 4 of screen combining parameter calculation processing in FIG. 3. A description of processing common to Operation Example 3 shown in FIG. 9 is omitted here.

The processing in step S4300 through step S4320 is the same as in Operation Example 3, and therefore a description thereof is omitted here.

Then, in step S4332, the loop length is determined. Specifically, the sub image loop length is calculated based on the size of the trigger value. For example, sub image loop length frame_num(t) is calculated using Expression (9) below.

$$frame\_num ( t ) = \frac{Trigger ( t )}{MAX\_Trigger} * MAX\_frame \_num \qquad Expression ( 9 )$$

frame_num(t): Sub image loop length at time t

Trigger(t): Trigger value at time t

MAX_Trigger: Maximum value possible as trigger value

MAX_frame_num: Maximum setting value for sub image loop length

As shown in Expression (9), the sub image loop length value increases as the size of the trigger value increases.

Expression (9) is only a sample calculation method, and calculation is not restricted to this method. Any loop length calculation method may be used whereby the loop length increases as the size of the trigger value increases.

The processing in step S4340 and step S4350 is the same as in Operation Example 3, and therefore a description thereof is omitted here.

Then, in step S5000, picture accumulation section 110 carries out picture accumulation processing. As described in Operation Example 3, picture accumulation section 110 has internal memory capable of storing a plurality of images, and stores images output from picture input section 102 in this internal memory. This internal memory has a storage counter indicating the storage location of an image, and a read counter indicating the read location of an image. The maximum value that can be held by each counter is the number of images that can be stored in internal memory, and when the counter value exceeds the maximum value after being updated, the counter value is set to 1 again. That is to say, the internal memory has a structure whereby periodic image data can be stored and read by updating counters each time image storage or reading is performed. In this operation example, control is performed so that the number of images that can be stored in internal memory is equal to the value indicated by the “loop length” combining parameter.

The description given here refers to FIG. 10, focusing on parts where processing differs from that in Operation Example 3.

First, in step S5100, memory initialization is performed. Specifically, the “combining scene central time” screen combining parameter and the previously input combining scene central time are compared, and if the two are different, initialization of the image data and counters in the internal memory is carried out. In this initialization, image data in internal memory is cleared, the counter values are reset to 1, and the number of images that can be stored in internal memory is set to the “loop length” screen combining parameter. In addition, the current combining scene central time is stored in internal memory.

The processing in step S5110 through step S5150 is the same as in Operation Example 3, and therefore a description thereof is omitted here.

Then, in step S5160, read counter updating is performed. Specifically, the read counter value is updated using Expression (10) below, for example.
count_read(t)=count_read(t−1)+1 Expression (10)

t: Current time

count_read(t): Read counter value at time t

If the read counter value exceeds the maximum value, the counter value is set to 1.

In the memory initialization processing in step S5100, the maximum number of images that can be stored in internal memory is changed in accordance with the screen combining parameters. By this means, it is possible to control the number of images in a scene to be combined as a sub image—that is, the size of the scene length. That is to say, the larger the trigger value, the larger is the length setting of a scene for loop playback, making it possible to play back a scene of extended length centered around the trigger generation time.

Thus, by controlling the maximum number of images stored in internal memory, it is possible to change the length of a scene to be combined as a sub image.

The processing in step S5170 and step S5180 is the same as in Operation Example 3, and therefore a description thereof is omitted here.

Next, in step S6000, as in Operation Example 1, a sub image is created using an image output from picture accumulation section 110 based on screen combining parameters output from screen configuration calculation section 108, and the created sub image is output to image information adding section 114.

When “loop combining” pattern 2 is performed as in this operation example, an image that is a sub image target output from picture accumulation section 110 and obtained by means of the read counter is reduced in size to create a sub image.

Then, in step S7000, as in Operation Example 1, the color of the border of a sub image output from sub image creation section 112 is changed in accordance with the “combining classification” screen combining parameter output from screen configuration calculation section 108, and a sub image whose border color has been changed is output to screen combining section 116.

When the combining classification is “loop combining” as in this operation example, the sub image border color is changed to yellow, as in Operation Example 3. However, the border color is not limited to yellow, and any color may be used as long as it enables the sub image to be identified as a loop playback image.

The processing in step S8000 and step S9000 is the same as in Operation Example 1, and therefore a description thereof is omitted here.

Thus, according to this operation example, image combining is performed so that a scene is played back repeatedly with control executed so that the larger the value of a trigger indicating the importance of a picture, the greater is the length of a scene comprising images around a trigger generation time, and therefore by coding a combined picture, transmitting it via a transmission path, and displaying it on a receiving terminal, a user can not only view the current picture, but also simultaneously view a scene around an important time as a composite screen, on a receiving terminal that has only one screen, and moreover the more important the scene, the longer is the scene length and the greater is the number of images around an important time that can be viewed.

Also, if the correspondence between border colors and sub image contents is known, the user can determine sub image contents from the border color of a sub image without transmitting or receiving information other than a composite picture.

In this operation example, an example has been shown in which an input image is displayed as the main image and an important scene as sub images, but this is not a limitation, and it is also possible to display an important scene as the main image and an input picture as a sub screen.

Furthermore, the number of input pictures is not limited to one, and loop combining is also possible in the case of a plurality of input pictures.

### OPERATION EXAMPLE 5

In Operation Example 5, a description is given of a case in which, when screen combining is performed as the result of screen combining determination using a combining trigger, a scene comprising images around a time at which a trigger is generated is combined as a sub image in an area of part of the input image so that that scene is played back repeatedly—that is to say, a case in which “loop combining” is performed. It is assumed here that, unlike in Operation Example 3 and Operation Example 4, the larger the trigger size, the greater is the set number of loop playback times for the scene to be played back repeatedly (pattern 3).

The description here refers to FIG. 3, focusing on parts where processing differs from that in Operation Example 1.

The processing in step S1000 through step S3000 is the same as in Operation Example 1, and therefore a description thereof is omitted here. However, as “loop combining” is performed in this operation example, the trigger classification is determined to be “important scene” in the combining trigger calculation processing in step S3000.

Then, in step S4000, using a combining trigger, screen combining determination and screen configuration calculation are performed, and screen combining parameters are calculated, in the same way as in Operation Example 1. As “loop combining” pattern 3 is performed in this operation example, four items are calculated as screen combining parameters: combining classification (here, “loop combining”), combining scene central time, number of loops, and frame counter. Here, “combining scene central time” is a parameter indicating the image number of an image located at the central time of a scene to be combined, as described above, “number of loops” is a parameter indicating the number of repetitions of a scene to be played back repeatedly as a sub image, as described above, and “frame counter” is a parameter indicating the remaining number of images to be combined as a sub image, as described above.

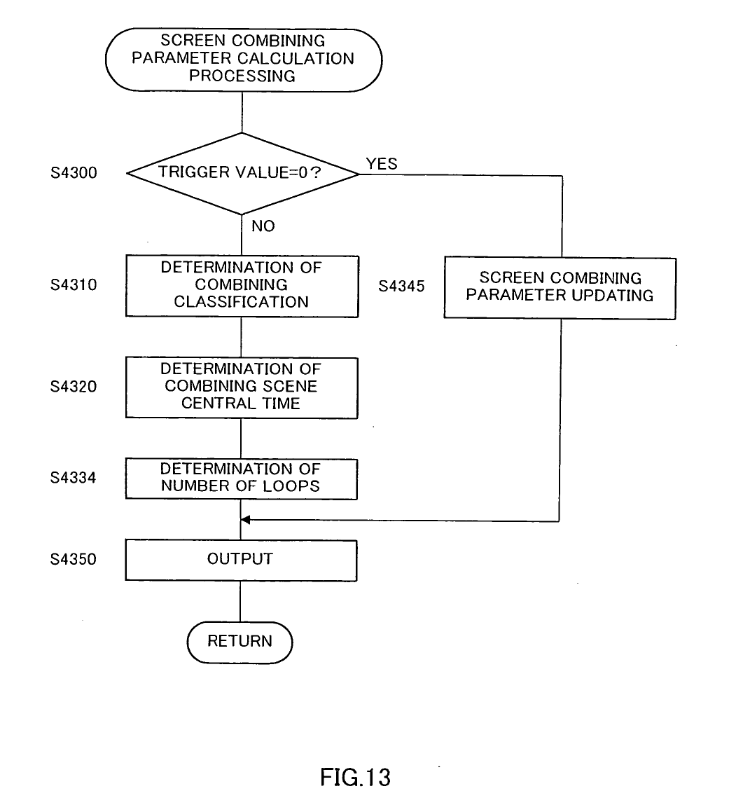

FIG. 13 is a flowchart showing the contents in Operation Example 5 of screen combining parameter calculation processing in FIG. 3. A description of processing common to Operation Example 3 shown in FIG. 9 is omitted here.

The processing in step S4300 through step S4320 is the same as in Operation Example 3, and therefore a description thereof is omitted here.

Then, in step S4334, the number of loops is determined. Specifically, the sub image number of loops is calculated based on the size of the trigger value, and frame counter setting is performed using a loop counter.

For example, sub image number of loops loop_num(t) is calculated using Expression (11) below.

$$loop\_num ( t ) = \frac{Trigger ( t )}{MAX\_Trigger} * MAX\_loop \_num \qquad Expression ( 11 )$$

loop_num(t): Sub image number of loops at time t

Trigger(t): Trigger value at time t

MAX_Trigger: Maximum value possible as trigger value

MAX_loop_num: Maximum setting value for sub image number of loops

As shown in Expression (11), the sub image number of loops value increases as the size of the trigger value increases.

Expression (11) is only a sample calculation method, and calculation is not restricted to this method. Any method of calculating the number of loops may be used whereby the number of loops increases as the size of the trigger value increases.

After the number of loops has been determined using Expression (11), the frame counter is set. Frame counter value frame_count (t) is calculated using Expression (12) below, for example.
frame_count(t)=loop_{—}num(t)*MAX_frame_{—}num Expression (12)

frame_count(t): Frame counter value at time t

loop_num(t): Sub image number of loops at time t

MAX_frame_num: Calculated using number of images that can be stored in internal memory of picture accumulation section 110

In step S4345, on the other hand, since the combining-trigger trigger value is zero—that is, there is no combining trigger input—unlike Operation Example 3, combining parameter updating is performed. Specifically, of the previous screen combining parameters, update processing is performed for the frame counter and combining method.

For example, the frame counter is updated by means of Expression (13) below.
frame_count(t)=frame_count(t−1)−1 Expression (13)

As shown in Expression (13), the frame counter is updated by decrementing its value by 1 each time. If the frame counter value becomes 0 or less when updated, the frame counter value is set to 0.

Next, combining classification update processing is performed in accordance with the updated frame counter value. Combining classification updating may be performed in accordance with the following rules, for example.
(1) When the frame counter value is 0, the combining classification is changed to “no combining.”
(2) When the frame counter value is not 0, the combining classification is not changed.

By performing screen combining parameter updating in this way, it is possible to set the combining classification of frames specified by the frame counter to “loop combining.” It is possible to control the number of loop playback times by having picture accumulation section 110 accumulate images in internal memory and simultaneously output images for loop playback to sub image creation section 112 in accordance with the combining classification.

In step S4350, the four screen combining parameters (combining classification, combining scene central time, number of loops, and frame counter) calculated in step S4300 through step S4345 are output to picture accumulation section 110, sub image creation section 112, image information adding section 114, and screen combining section 116, the input picture (input image from picture input section 102) is output to screen combining section 116, and then the main flowchart in FIG. 3 is returned to.

The processing in step S5000 through step S9000 is the same as in Operation Example 3, and therefore a description thereof is omitted here.

Thus, according to this operation example, image combining is performed with control executed so that the larger the value of a trigger indicating the importance of a picture, the greater is the number of loops for repeated playback of a scene comprising images around a trigger generation time, and therefore by coding a combined picture, transmitting it via a transmission path, and displaying it on a receiving terminal, a user can not only view the current picture, but also simultaneously view pictures around an important time as a composite screen, on a receiving terminal that has only one screen, and moreover the more important the scene, the greater is the number of loops of the scene and the greater is the number of repetitions of images around an important time.

Also, if the correspondence between border colors and sub image contents is known, the user can determine sub image contents from the border color of a sub image without transmitting or receiving information other than a composite picture.

In this operation example, an example has been shown in which an input image is displayed as the main image and an important scene as sub images, but this is not a limitation, and it is also possible to display an important scene as the main image and an input picture as a sub screen.

Furthermore, the number of input pictures is not limited to one, and loop combining is also possible in the case of a plurality of input pictures.

### OPERATION EXAMPLE 6

Operation Example 6 illustrates a case in which the size of a sub image is changed in accordance with the size of a trigger. Here, as an example, a description is given of a case in which, when screen combining is performed as the result of screen combining determination using a combining trigger, the image at the time when the trigger is generated is made a still picture, and this still picture is combined as a sub image in an area of part of the input image—that is to say, a case in which “still picture combining” is performed. It is assumed here that the larger the trigger size, the larger is the sub image size set.

Changing the sub image size in accordance with the trigger size can also be applied to combining classifications other than “still picture combining,” such as “cut-out combining” and “loop combining.”

The description here refers to FIG. 3, focusing on parts where processing differs from that in Operation Example 1.

The processing in step S1000 through step S3000 is the same as in Operation Example 1, and therefore a description thereof is omitted here.

Then, in step S4000, using a combining trigger, screen combining determination and screen configuration calculation are performed, and screen combining parameters are calculated, in the same way as in Operation Example 1. In this operation example, sub image size is calculated in addition to the “loop combining” screen combining parameters. Thus, four items are calculated as screen combining parameters: combining classification (here, “still picture combining”), target sub image, sub image display time, and sub image size. Here, “target sub image” is a parameter indicating the image number of an image to be used in sub image creation, as described above, “sub image display time” is a parameter indicating the time for which a sub image is continuously displayed when combined, as described above, and “sub image size” is a parameter indicating the sub image combining size.

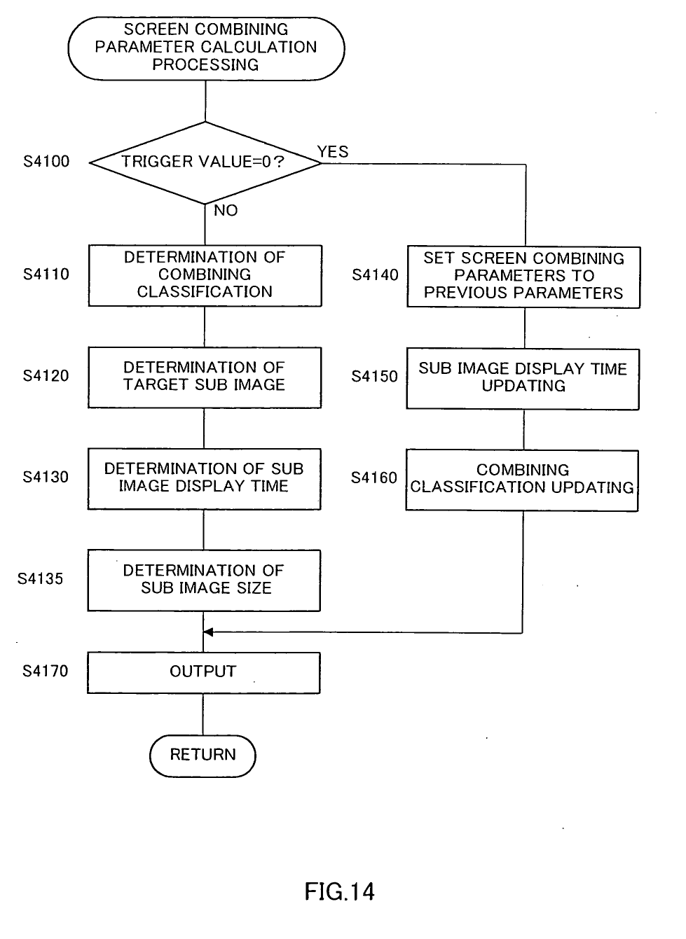

FIG. 14 is a flowchart showing the contents in Operation Example 6 of screen combining parameter calculation processing in FIG. 3. A description of processing common to Operation Example 1 shown in FIG. 4 is omitted here.

The processing in step S4100 through step S4130 is the same as in Operation Example 1, and therefore a description thereof is omitted here.

Then, in step S4135, the sub image size is determined. For example, sub image horizontal size sub_size_h(t) and vertical size sub_size_v(t) are calculated using Expression (14) and Expression (15) below, respectively.

$$\begin{matrix}{sub\_size}_{—} h ( t ) = \frac{Trigger ( t )}{MAX\_Trigger} * MAX\_size \_h & Expression ( 14 ) \\ sub\_size \_v ( t ) = \frac{Trigger ( t )}{MAX\_Trigger} * MAX\_size \_v & Expression ( 15 )\end{matrix}$$

sub_size_h(t): Horizontal size of sub image at time

sub_size_v(t): Vertical size of sub image at time

Trigger(t): Trigger value at time t

MAX_Trigger: Maximum value possible as trigger value

MAX_size_h: Maximum setting value for sub image horizontal size

MAX_size_v: Maximum setting value for sub image vertical size

As shown in Expression (14) and Expression (15), the sub image size increases as the size of the trigger value increases.

Expression (14) and Expression (15) are only sample calculation methods, and calculation is not restricted to these methods. Any sub image size calculation method may be used whereby the size increases as the size of the trigger value increases.

The processing in step S4140 through step S4170 is the same as in Operation Example 1, and therefore a description thereof is omitted here.

Also, in the main flowchart in FIG. 3, the processing in step S5000 through step S9000 is the same as in Operation Example 1, and therefore a description thereof is omitted here. However, in sub image creation in step S6000, sub image creation is performed by reducing a sub image target picture output from picture accumulation section 110 to the sub image size output from screen configuration calculation section 108. By creating a sub image using the sub image size in this way, it is possible to control the size of a sub image in accordance with a trigger value.

Thus, according to this operation example, image combining is performed with control executed so that the larger the value of a trigger indicating the importance of a picture, the larger is the sub image size when an image at the time of trigger generation is combined as a still picture, and therefore by coding a combined picture, transmitting it via a transmission path, and displaying it on a receiving terminal, a user can not only view the current picture, but also simultaneously view an image of an important time as a composite screen, on a receiving terminal that has only one screen, and moreover the more important the image, the larger is the image size, and the greater is the detail in which the image can be viewed on one screen.

Also, if the correspondence between border colors and sub image contents is known, the user can determine sub image contents from the border color of a sub image without transmitting or receiving information other than a composite image.

In this operation example, an example has been shown in which an input image is displayed as the main image and an important still picture as a sub image, but this is not a limitation, and it is also possible to display an important still picture as the main image and an input image as a sub screen.

Furthermore, the number of input pictures is not limited to one, and still picture combining is also possible in the case of a plurality of input pictures.

### OPERATION EXAMPLE 7

Operation Example 7 illustrates a case in which a screen configuration is calculated using a trigger indicating the importance of a picture, and combining information is represented by the shape of the screen for combining.

It is here assumed that screen configuration calculation section 108 calculates screen combining parameters by any one of the methods in Operation Example 1 through Operation Example 6, and the processing of image information adding section 114, in particular, is described below.

Image information adding section 114 changes the shape of a sub image output from sub image creation section 112 in accordance with the “combining classification” screen combining parameter output from screen configuration calculation section 108. For example, if the combining classification is “still picture combining,” the shape of the sub image is changed to a circle. However, the shape of the border is not limited to a circle, and any shape may be used as long as it enables the sub image to be identified as a still picture. Also, it is possible to represent the combining classification by means of the shape of a sub image, such as by using a rectangle when the combining classification is “cut-out combining,” and a triangle when the combining classification is “loop combining.” In this case, image information adding section 114 outputs a sub image changed to a shape indicating the combining classification to screen combining section 116.

Thus, according to this operation example, screen combining is performed in accordance with a trigger, and image combining is performed with control executed so that the shape of a sub image is changed in accordance with the combining classification of the sub image, and therefore by coding a combined picture, transmitting it via a transmission path, and displaying it on a receiving terminal, a user can not only view the current picture, but also simultaneously view a picture of an important location, on a receiving terminal that has only one screen.

As the combining classification of a sub image is represented by the shape of the sub image, if the correspondence between sub image shapes and sub image contents is known, the user can determine the combining classification of a sub image from the shape of the sub image without transmitting or receiving information other than a composite picture.

As described above, according to the present invention, a picture combining apparatus that combines a plurality of pictures in one screen can automatically display a picture that is important to the user, and furthermore can display that important picture combined in a screen configuration that is clearly perceptible visually.

This application is based on Japanese Patent Application No.2003-047354 filed on Feb. 25, 2003, the entire content of which is expressly incorporated by reference herein.

### INDUSTRIAL APPLICABILITY

The present invention has an effect of automatically displaying a picture that is important to the user, and furthermore displaying that important picture combined in a screen configuration that is highly appealing visually, and is useful in a picture combining apparatus that combines a plurality of pictures in one screen.

1. A picture combining apparatus that combines a plurality of pictures in one screen, said picture combining apparatus comprising:
a picture input section that inputs a picture;
a trigger generation section that generates a trigger indicating an importance of the picture;
a screen configuration calculation section that calculates a screen configuration in accordance with the importance of the generated trigger;
an image creation section that creates an image to be combined, from the input picture based on the calculated screen configuration; and
a screen combining section that combines a plurality of images including the created image in one screen.

2. The picture combining apparatus according to claim 1, wherein:
said trigger generation section has a motion detection sensor that detects a motion in the picture and outputs a signal in accordance with a magnitude of the detected motion; and
said importance is calculated in accordance with a size of the signal output by said motion detection sensor.

3. The picture combining apparatus according to claim 1, wherein:
said trigger generation section has a motion recognition sensor that recognizes a specific motion in the picture and outputs a signal in accordance with a magnitude of the recognized motion; and
said importance is calculated in accordance with a size of the signal output by said motion recognition sensor.

4. The picture combining apparatus according to claim 1, wherein:
said trigger generation section has an image recognition sensor that performs an image recognition of a specific object in the picture and outputs a signal in accordance with a degree of certainty of a result of the image recognition; and
said importance is calculated in accordance with a height of the degree of certainty of the image recognition result output by said image recognition sensor.

5. The picture combining apparatus according to claim 1, wherein:
said trigger generation section has an apparatus that accepts a screen combining request from a user; and
said importance accords with said screen combining request from the user.

6. The picture combining apparatus according to claim 1, wherein:
said trigger generation section further outputs a time at which the trigger is generated; and
said screen configuration calculation section calculates the screen configuration in which the picture of said trigger generation time as a still picture is combined with another image.

7. The picture combining apparatus according to claim 6, wherein said screen configuration calculation section controls a display time when an image of a time at which the trigger is generated is displayed as the still picture in accordance with a magnitude of the importance of the trigger.

8. The picture combining apparatus according to claim 7, wherein said screen configuration calculation section sets said display time longer for a greater magnitude of the importance of the trigger.

9. The picture combining apparatus according to claim 1, wherein:
said trigger generation section further outputs a location at which said trigger is generated; and
said screen configuration calculation section calculates the screen configuration in which an image of an area centered on said trigger generation location is cut out and combined with another image.

10. The picture combining apparatus according to claim 9, wherein said screen configuration calculation section controls a cut-out size when the image of the area centered on the trigger generation location is cut out in the picture in accordance with a magnitude of the importance of the trigger.

11. The picture combining apparatus according to claim 10, wherein said screen configuration calculation section sets said cut-out size smaller for a greater magnitude of the importance of the trigger.

12. The picture combining apparatus according to claim 1, wherein:
said trigger generation section further outputs a time at which the trigger is generated; and
said screen configuration calculation section calculates the screen configuration in which a scene composed of a group of images before and after said trigger generation time is combined with another image while being displayed repeatedly.

13. The picture combining apparatus according to claim 12, wherein said screen configuration calculation section controls a playback speed when the scene composed of the group of images before and after the trigger generation time is displayed repeatedly in the picture in accordance with a magnitude of the importance of the trigger.

14. The picture combining apparatus according to claim 13, wherein said screen configuration calculation section sets said playback speed slower for a greater magnitude of the importance of the trigger.

15. The picture combining apparatus according to claim 12, wherein said screen configuration calculation section controls a number of images comprising of the scene when the scene composed of the group of images before and after the trigger generation time is displayed repeatedly in the picture in accordance with a magnitude of the importance of the trigger.

16. The picture combining apparatus according to claim 15, wherein said screen configuration calculation section sets said number of images comprising of the scene larger for a greater magnitude of the importance of the trigger.

17. The picture combining apparatus according to claim 12, wherein said screen configuration calculation section controls a number of repetitions when the scene composed of the group of images before and after the trigger generation time is displayed repeatedly in the picture in accordance with a magnitude of the importance of the trigger.

18. The picture combining apparatus according to claim 17, wherein said screen configuration calculation section sets said number of repetitions larger for a greater magnitude of the importance of the trigger.

19. (deleted)

20. (deleted)

21. The picture combining apparatus according to claim 1, further comprising an image information adding section that adds to the image created by said image creation section information indicating a classification of the image.

22. The picture combining apparatus according to claim 21, wherein said image information adding section represents a classification of the image created by said image creation section by means of a color of a border of the image.

23. The picture combining apparatus according to claim 21, wherein said image information adding section represents a classification of the image created by said image creation section by means of a shape of the image.

24. The picture combining apparatus according to claim 21, wherein:
said image combining section executes one of still picture combining, cut-out combining, or loop combining; and
said image information adding section adds to said image said image classification information corresponding to one of said still picture combining, said cut-out combining, or said loop combining.
